(19) United States
(12) Patent Application Publication
(10) Pub. No.: US 2006/0065713 A1
(43) Pub. Date: Mar. 30, 2006

(54) System and method for monitored administration of medical products to patients

(76) Inventor: John Russell Kingery, Eden Prairie, MN (US)

Correspondence Address: ATMI, INC., 7 COMMERCE DRIVE, DANBURY, CT, 06810, US

(21) Appl. No.: 10/949,786

(22) Filed: Sep. 24, 2004

(51) Int. Cl. G06K 5/00; G06Q 30/00

(52) U.S. Cl. 235/380; 235/385

(57) ABSTRACT

A system and method for monitored administration of medical products to patients. In one implementation, the system includes: an RFID tag article disposable on or in proximity to a patient, including a first RFID tag containing first information relevant to administration of medical product to the patient; a medical product labeled with a second RFID tag containing second information relevant to administration of the medical product to the patient; a reader arranged to receive signals from at least one of the first and second RFIDs; and a controller operatively coupleable in communication with the reader to process information received by the reader and to responsively generate an output relating to treatment of the patient.

### FIELD OF THE INVENTION

The present invention relates to a system and method of monitored administration of medical products to patients.

### DESCRIPTION OF THE RELATED ART

In the dispensing of blood products, intravenous fluids and various other medicaments to patients in hospital and other medical treatment facilities, it is common practice to supply these therapeutic materials in polymeric bags. These bags facilitate storage and transport of the therapeutic materials. At the site of use, the bags are coupled to administration devices, such as drip catheters, infusion pumps, power syringes, shunts, and the like, for delivery of the required therapeutic material to the patient.

In the usage and tracking of such bags, manual and paper systems have been employed for date coding and specifying the contents of bags at the supplier facility where such bags are filled with the medical product to be subsequently dispensed in the hospital or other medical facility. At such end use location, the bag's tracking, usage, matching to prescription for the patient, timing of use, etc. are typically handled in a manner that is manual effort-intensive, and prone to the occurrence and propagation of human error.

It would therefore be highly advantageous to provide a system and methodology for monitored administration of medical products to patients that resolves issues associated with the manual effort-intensive approaches of the prior art.

### SUMMARY OF THE INVENTION

The present invention relates generally to a system and method of monitored administration of medical products to patients.

In one aspect, the present invention relates to a system for administration of medical products to patients, including:
an RFID tag article disposable on or in proximity to a patient, including a first RFID tag containing first information relevant to administration of medical product to the patient;
a medical product labeled with a second RFID tag containing second information relevant to administration of the medical product to the patient;
a reader arranged to receive signals from at least one of the first and second RFIDs; and
a controller operatively coupleable in communication with the reader to process information received by the reader and to responsively generate an output relating to treatment of the patient.

In another aspect, the invention relates to a system for administration of medical products, comprising an RFID tag containing information relevant to treatment of a patient, a reader, such as a read/write antenna, arranged to receive signals from the RFID tag, and a controller operatively coupleable in communication with the reader to process information received by the reader and to responsively generate an output relating to treatment of the patient.

In a further aspect, the invention relates to a medical fluid bag stand, including an RFID antenna for reading bags labeled with RFID tags that are mounted on the stand.

Yet another aspect of the invention relates to a method of administering medical products to patients, comprising providing an RFID tagged patient and an RFID tagged medical product for said patient, wherein RFID tags for said patient and said medical product contain information relevant to administration of said medical product to said patient, and processing information from said RFID tags to produce an output relating to treatment of said patient.

A still further aspect of the invention relates to a method of administering medical products to patients, comprising providing an RFID tag containing information relevant to treatment of a patient, reading said information with a reader, and processing the read information to produce an output relating to treatment of said patient.

Other aspects, features and advantages of the invention will be more fully apparent from the ensuing disclosure and appended claims.

### BRIEF DESCRIPTION OF THE DRAWINGS

FIG. 1 is a schematic representation of a system and method of monitored administration of medical products to patients, according to one embodiment of the invention.

### DETAILED DESCRIPTION OF THE INVENTION AND PREFERRED FEATURES THEREOF

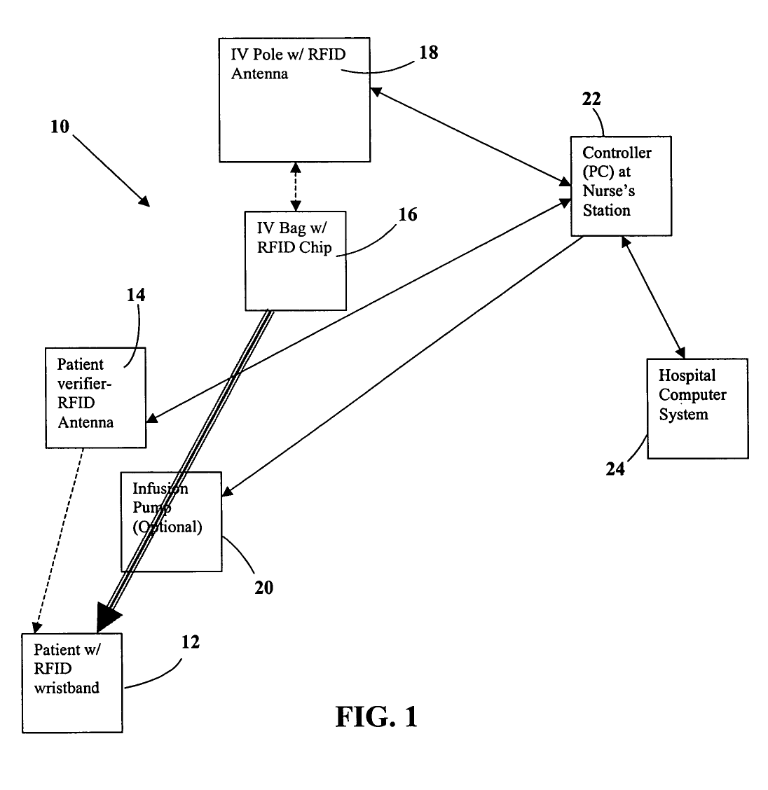

Referring now to the drawings, FIG. 1 is a schematic representation of a system 10 for monitored administration of medical products to a patients, according to one embodiment of the invention.

The system 10 includes a patient with an RFID wristband 12. The wristband can be of any suitable type, including a band, strap or other support member circumscribing the wrist of the patient for affixation of the wristband to the body of the patient. In lieu of a wristband, the patient may be equipped with a neckband, headband, armband, belt such as for example a waistbelt, ankleband, or other wearable or body-mountable support. The support member has associated therewith a radio frequency identification (RFID) tag capable of electronically storing information. Alternatively, the RFID tag-equipped article could be disposed on or in proximity to the patient as an article of clothing, such as a hospital gown tagged with an RFID tag, or a blanket placed over the patient in a hospital bed. The RFID tag could even be provided in the form of an implantable chip that is subcutaneously inserted into the patient, or in the form of an adhesive patch or badge that is secured to the person of the patient, e.g., using an adhesive of the type used in securing external bags to colostomy patients.

The RFID tag itself can be of any suitable type. The RFID tag includes a memory for data storage, which may for example be constituted by a read-only memory or alternatively a read/write memory, as well as an antenna, transponder or transceiver for communication with a reader. The reader may be a read/write unit. As an illustrative example, the RFID tag can include a passive RF transponder and an electrically erasable programmable read-only memory (EEPROM). The RFID tag can also include power supply and processor/controller components to facilitate information processing and communications with the reader. In one illustrative arrangement, the RFID tag can include a Tag-It® RFID chip commercially available from Texas Instruments (Dallas, Tex.), encodable by a commercially available encoder unit to enable the RFID tag to contain the information of interest.

The information contained in the RFID tag associated with the support article that is worn or in close proximity to the patient can be any information that is clinically and/or operationally useful in effecting the treatment and management of the patient. Such information may for example include, without limitation, patient age, gender, allergies, salient medical history, current or preexisting conditions or susceptibilities, address, identity of attending and referring physicians, next of kin or affiliate or to-be-contacted individuals, living will provisions, healthcare powers of attorney, currently applicable prescriptions for treatment and/or medication, medication side effect susceptibilities, dose form instructions for medication, dosage regimen, surgical schedule, dietary instructions, medical insurance information, etc., as may be necessary or desired for a given patient.

Thus, while the illustrative embodiment contemplates a patient wristband, it will be appreciated that any RFID tag-equipped article may be disposed on or in close proximity to the patient, and that any appropriate information can be stored in the RFID tag.

The system also includes a reader 14 in the form of a patient verifier RFID antenna unit. Such reader advantageously can be embodied in an illustrative form of the invention as a handheld unit that can be used by a physician, nurse or medical emergency technician to query and read the RFID tag on or in close proximity to the patient. The data on the tag may be read by the reader by transmission of a radio frequency query to the RFID tag and receipt of a response signal from the tag, facilitated by the antenna. The reader 14 may include signal processing circuitry components for processing of the response signal from the RFID tag. The reader is constructed and arranged to read the tag and to responsively send a corresponding signal via its antenna to the controller 22.

The controller 22 may be constituted by a general purpose programmable digital computer or central processing unit (CPU) arranged as part of a terminal including memory and processor components. The processor may be arranged to communicate with the memory by means of an address/data bus, and can be constituted by a commercially available or custom microprocessor. The memory can include, without limitation, devices of varied type, such as cache, ROM, PROM, EPROM, EEPROM, flash memory, SRAM, and DRAM.

The memory may include several categories of software and data used in the data processing system: the operating system; the application programs; the input/output (I/O) device drivers and the data. The data may include a database of known profiles and/or data from the RFID tag on or in proximity to the patient. The database may alternatively, or additionally, include a database of known features and specifications from the RFID tag on the product.

It will be appreciated that the operating system in the controller 22 can be of any suitable type for use with a data processing system. Illustrative examples of operating systems that can be usefully employed include, without limitation, OS/2, AIX, OS/390 or System390 (International Business Machines Corporation, Armonk, N.Y.), Windows CE, Windows NT, Windows95, Windows98, Windows2000, or WindowsXP (Microsoft Corporation, Redmond, Wash.), Unix or Linux or FreeBSD, Palm OS from Palm, Inc., Mac OS (Apple Computer, Inc.), LabView or proprietary operating systems.

The I/O device drivers typically include software routines accessed through the operating system by the application programs to communicate with devices such as I/O data port(s), data storage and certain components of the memory.

The application programs are illustrative of the programs that implement the various features of the system and can suitably include one or more applications that support analysis of the data. The data represent the static and dynamic data used by the application programs, the operating system, the I/O device drivers, and other software programs that may reside in the memory.

Any configuration of the controller capable of carrying out the operations for the methodology of the invention can be advantageously employed.

The I/O data port of the controller 22 can be used to transfer information between the controller and another computer system or a network (e.g., the Internet) or to other devices controlled by the processor.

In one embodiment, the controller is constituted as a computer terminal disposed at a nurses' station of a hospital, and interconnected as shown to a hospital computer system 24. Such connection may be wired or wireless in character.

The memory in the controller 22 may include a database of the patient's information, including information of the general type contained in the RFID tag on or in proximity to the patient, for verification purposes, tracking, longitudinal monitoring, predictive or correlative functions or other information processing functions. The handheld patient verifier reader 14 thus is able to query the RFID tag of wristbanded patient 12 and send the information to the controller 22 for verification of the correct patient.

The system 10 shown in FIG. 1 further includes an IV bag 16 equipped with an RFID tag. The bag may be formed of a conventional polymeric thin film material and have the RFID tag secured to an exterior surface of the bag, in the nature of a conventional label. Alternatively, the RFID tag may be incorporated in a multilaminate film forming a panel of the bag, sandwiched between successive layers of the multilaminate film so as to protect the RFID tag element from degradative attack by ambient liquids or gases.

The information contained by the RFID tag may variously include, without limitation, one or more of: the identity of the medical product in the bag, its concentration or strength, compositional ingredients, manufacturing or processing date of the product, the fill date of the bag, the manufacturer of the medical product and/or the bag itself, the volume of the bag, the temperature at which the medical product is desirably administered, the dispensing rate for the medical product, the shelf life/expiration date of the medical product, appropriate settings of any associated valve/drip tube/pump devices or other delivery apparatus with which the bag is employed, as well as general instructions for the use, storage, transport and administration of the medical product.

The system 10 further includes in the embodiment shown in FIG. 1 an IV pole 18 incorporating an RFID antenna adapted for communication with the RFID tag on the RFID tagged bag 16. The RFID antenna on the IV pole 18 is thereby arranged for receiving an informational signal from the RFID tag on bag 16 and to responsively transmit a correlative signal to the controller 22. The RFID antenna thus embodies a reader for the IV bag's RFID tag. For this purpose, the reader may be constructed as a separable module that is detachably connected to the IV pole, e.g., by quick-disconnect coupling elements. Alternatively, the RFID antenna reader unit may be integrally formed in the structure of the IV pole 18, e.g., by the reader unit having a cylindrical shape and being disposed internally in the interior lumen of the tubular IV pole.

The RFID tags on the wristband or other support article associated with the patient, as well as the RFID tags on the medical product bags, may be of a powered type having a power supply integral to the tag unit, or alternatively may be inductively coupled to the associated antenna of the reader so as to respond to a query signal from the antenna.

The system 10 optionally further includes an infusion pump 20 arranged to be coupled to the patient, e.g., by a catheter, shunt, infusion needle set, or other delivery device. The pump 20 also is arranged to be coupled to the IV bag 16, such as by means of tubing, connectors, clamps, etc., whereby the contents of the bag are able to be flowed for delivery to the patient under the action of the infusion pump.

The pump is an optional feature of the illustrative system embodiment shown in FIG. 1. In the absence of such pump, the bag 16 may be coupled to the patient 12 via a gravity-flow drip set, and a catheter, shunt, infusion needle set, or other delivery device for administration to the patient.

In an illustrative operation of the system depicted in FIG. 1, a nurse or other healthcare attendant verifies the patient 12 by checking the RFID wristband with the handheld patient verifier reader 14. The antenna on the patient verifier reads the patient RFID tag and sends the information to the controller 22 for verification of the correct patient.

The nurse or attendant then places an IV bag 16 on the IV pole 18. When the IV bag 16 is placed on the pole 18, the antenna on the pole automatically reads the RFID tag on the IV bag and sends the information to the controller 22 at the nurses' station.

The controller 22 at the nurses' station has the doctor's orders for the patient and the patient's medical information entered into it. The controller checks the information sent to it by the IV pole antenna and by the patient verifier antenna, and compares the information with the doctor's orders and the patient's medical information, as well as medical product identity, expiration date, etc. from the IV bag itself.

If all information is verified as being appropriate, the controller 22 automatically sends a signal to the nurse (to the patient verifier unit 14) that all information has been verified and the patient therefore can proceed to receive the medical product, in this case the IV solution in the bag. The nurse then can initiate administration of the IV fluid to the patient. In another variation, the controller 22 upon verification that all patient, product and system information is appropriate, sends a signal to the infusion pump 20 to actuate the pump and allow the IV fluid to be delivered to the patient.

If, however, all information is not verified as being appropriate by the controller, the controller automatically sends a signal to the nurse (to the patient verifier unit 14) that reflects the inability to verify all patient, product and system information, so that the nurse does not undertake the IV administration procedure. In another mode of operation, the controller 22 sends a signal to the optional infusion pump 20, preventing the pump from being actuated, and actuates an alarm at the nurses' station, e.g., through speakers associated with the sound system of the controller 22 terminal. In yet another mode of operation, the controller 22 sends messages to the patient's physicians, e.g., via the hospital computer system 24 and associated wired or wireless network, e.g., to pagers, personal digital assistants, or cellular phones of such physicians.

It will be understood that the foregoing modes of operation in the event of non-verification of all patient, product and system information, can be conducted, either singly, jointly, alternatively, or in any permutations of such non-verification response actions.

In specific arrangements of the FIG. 1 system, a single controller 22 at the nurses' station can simultaneously handle multiple IV installations (e.g., up to 32, up to 64, or even more) in the hospital, with each IV installation having its own criteria.

The controller 22 terminal can be arranged to display (e.g., by radio buttons, cursor control operations, or other input actuation) any of the multiplicity of IV installations in the system. For example, the controller 22 may be programmably arranged with a monitor to display a touch screen whereby any one or more of the multiple IV installations in the system can be instantly accessed for real-time monitoring of status, progress of administration of the medical product, etc.

As another alternative, the controller 22 may be programmably arranged to provide automated alerts (e.g., by actuation of alarms, monitor screen displays of alert messages or colorimetric indications, etc.) of the occurrence of any events or circumstances requiring intervention at any of the monitored IV installations.

In another implementation, an RF antenna, e.g., integrated in an IV stand, or otherwise present at the patient location, is arranged to receive patient monitoring information, such as body vital signs (heart rate, temperature, blood pressure, etc.) and to transmit same to the controller 22. The patient information may be read by the antenna from an RFID tag on or in proximity to the patient, or from a plurality of such RFID tags, containing such information. Alternatively, the antenna may be arranged to read patient information directly from a monitoring device adapted for such direct monitoring, for example a pulse oximeter, blood pressure monitoring cuff, etc. As a still further arrangement, the monitoring device may be coupled with an RFID tag to transmit patient monitoring data to the RFID tag for subsequent reading by the RF antenna and transmission to controller 22.

As a still further alternative or additional feature, the controller 22 may be programmably arranged to provide, in addition to verification of the specific bag of medical product for administration to a specific patient, and continuous monitoring of all IV installations in the system, a record of all events in system operation, and reports according to specific report criteria or schedules.

The controller 22, by virtue of being coupled in a wired or wireless fashion to the hospital computer system 24, is arranged to transmit information to the hospital computer system in order to administer billing functions, inventory control, and process automation.

In a specific implementation, the patient verifier 14 can be provided in the form of a smart card article. The smart card article, preferably fabricated in compliance with international standard ISO 7816, can be configured in any suitable manner for such purpose, including for example a credit card-size plastic card with an embedded microprocessor and memory. In such implementation, the controller 22 is configured as a host for the smart card, or a plurality of smart cards.

In one embodiment of such implementation, the smart card includes multiple, e.g., four, RFID antenna connections, with each antenna connection running to a separate patient bed/IV stand, and with each IV stand having an RF antenna integrated into the IV bag hook portion of the stand article. In this manner, the smart card is arranged to communicate with RFID tags on or in proximity to a particular patient 12, such as at a hospital bed location, as well as being arranged to communicate with RFID tags on the bags 16 that are utilized in treatment of that patient. The smart card may then be passed over a scanner integrated with the controller 22 to transfer data from the smart card to the controller, or alternatively, the smart card can transmit data to the controller 22 via wireless or wired transmission.

The IV stand in the above-described implementation of the invention can be configured with an output unit that indicates visually to the healthcare attendant whether all data has been verified in the RFID tag/reader/controller system, and that it is appropriate to proceed with the therapeutic intervention, e.g., start the IV bag for administration of IV fluid to the patient. Such output unit can in one embodiment be configured as a two-color LED display, in which for example a green LED illumination indicates the verification of all patient, system and medical product information, and in which a red LED illumination indicates the non-verification of all patient, system and medical product information.

The output unit in another embodiment includes a valve arranged for control of the fluid supply line connected to the IV bag, which is arranged to response operationally to open when all patient, system and medical product information has been verified, and to close when patient, system and medical product information has not been verified.

The verification function involves data that can be added to the patient's records as an update in the files of the patient's history maintained in the central records of the hospital computer system 24 and/or on the controller 22 computer as resident data. Such update data can also be read to the RFID tag, e.g., by the reader 14 configured for corresponding read/write operation.

It will therefore be appreciated that the system of the present invention accommodates centralized local control of multiple patient installations in a manner that permits electronic approval procedures to be utilized that increase the safety and reliability of the medical product administration procedure, enables the tracking of critical medical products and improves inventory control, patient billing, insurance processing, and quality of care.

Additionally, it will be appreciated that while the invention has been described herein with primary reference to fluid medical products such as intravenous solutions and blood products, the invention is not thus limited in application, and may be employed for monitored administration of other medical products including pills and other solid medicament dose forms, transdermal patches, anaesthesia gases, foods of a prescribed dietary regimen, oxygen or other breathing gases, or any medical products whose administration in the care of patients is beneficially monitored and controllably carried out.

Accordingly, although the invention has been described herein with reference to illustrative features, aspects and embodiments, it will be appreciated that the invention may be practiced with modifications, variations and in other embodiments, as will suggest themselves to those of ordinary skill based on the disclosure herein. The invention therefore is to be interpreted and construed, as encompassing all such modifications, variations, and other embodiments, within the spirit and scope of the claims hereafter set forth.

What is claimed is:

1. A system for administration of medical products to patients, comprising:
an RFID tag article disposable on or in proximity to a patient, including a first RFID tag containing first information relevant to administration of medical product to the patient;
a medical product labeled with a second RFID tag containing second information relevant to administration of the medical product to the patient;
a reader arranged to receive signals from at least one of the first and second RFIDs; and
a controller operatively coupleable in communication with the reader to process information received by the reader and to responsively generate an output relating to treatment of the patient.

2. The system of claim 1, wherein the RFID tag article includes a support disposable on or in proximity to the patient.

3. The system of claim 2, wherein the support comprises a body-mountable support.

4. The system of claim 2, wherein the support comprises a support member selected from the group consisting of: wristbands; armbands; legbands; anklebands; neckbands; belts; headbands; garments; and blankets.

5. The system of claim 2, wherein the RFID tag article comprises an implantable chip.

6. The system of claim 2, wherein the RFID tag article comprises a patch or badge securable to the person of the patient.

7. The system of claim 1, wherein each of said RFID tags includes componentry selected from the group consisting of memory, antenna, transponder, and transceiver components.

8. The system of claim 1, wherein at least one of the first and second RFID tags includes a read-only memory.

9. The system of claim 1, wherein at least one of the first and second RFID tags includes a read/write memory.

10. The system of claim 1, wherein the reader includes a read/write unit.

11. The system of claim 1, wherein the first information includes information selected from the group consisting of: patient age, gender, allergies, salient medical history, current and preexisting conditions and susceptibilities, address, identity of attending and referring physicians, next of kin and affiliate and to-be-contacted individuals, living will provisions, healthcare powers of attorney, currently applicable prescriptions for treatment and/or medication, medication side effect susceptibilities, dose form instructions for medication, dosage regimen, surgical schedule, dietary instructions, and medical insurance information.

12. The system of claim 1, wherein the RFID tag article includes a patient wristband having the first RFID tag mounted thereon.

13. The system of claim 1, wherein the reader includes a handheld reader unit.

14. The system of claim 1, wherein the controller is disposed at a nurses' station of a healthcare facility.

15. The system of claim 14, wherein the controller comprises a computer terminal networked to a computer system of the healthcare facility.

16. The system of claim 14, wherein the controller includes a database of patient information for said patient.

17. The system of claim 1, wherein the medical product comprises an IV fluid.

18. The system of claim 1, wherein the medical product comprises a blood product.

19. The system of claim 1, wherein the medical product is provided in a bag container.

20. The system of claim 19, wherein the second RFID tag is affixed to an exterior surface of said bag.

21. The system of claim 19, wherein the second RFID tag is disposed between successive layers of a multilaminate film forming at least a portion of said bag.

22. The system of claim 1, wherein the second information includes information selected from the group consisting of: identity of the medical product, its concentration and strength, compositional ingredients, manufacturing and processing date of the product, fill date of packaging containing the medical product, manufacturer of the medical product and/or the packaging, volume of the medical product, temperature at which the medical product is desirably administered, dispensing rate for the medical product, shelf life/expiration date of the medical product, appropriate settings of delivery apparatus with which the medical product is delivered, and general instructions for use, storage, transport and administration of the medical product.

23. The system of claim 1, further comprising an IV stand for mounting of the medical product labeled with the second RFID tag, wherein the IV stand includes an RFID antenna adapted for communication with the second RFID tag and coupled in communication with the controller.

24. The system of claim 23, wherein the RFID antenna is internally disposed in the IV stand.

25. The system of claim 23, wherein the RFID antenna is detachably secured to the IV stand.

26. The system of claim 1, wherein the medical product comprises a fluid, and the system further comprises a pump for pumping the fluid to the patient, with the controller being arranged to control the pump by the responsively generated output.

27. The system of claim 26, wherein the responsively generated output alternatively enables or disables the pump.

28. The system of claim 26, wherein the responsively generated output modulates pumping action of the pump.

29. The system of claim 1, wherein the reader includes (i) a first handheld reader arranged to monitor the first RFID tag and (ii) an RF antenna arranged to monitor the second RFID tag.

30. The system of claim 1, wherein the controller is adapted to transmit the output relating to the treatment of the patient to the patient's treatment provider via a receiving device selected from the group consisting of pages, personal digital assistants, and cellular phones.

31. The system of claim 1, wherein the controller is adapted to actuate an alarm when the output relating to treatment of the patient contraindicates administration of the medical product to the patient.

32. The system of claim 1, wherein the controller is operatively arranged to receive signals from both of the first and second RFIDs.

33. The system of claim 1, wherein the controller is operatively arranged to receive signals from RFID tags associated with a plurality of patients.

34. The system of claim 33, wherein the plurality includes up to 32 patients.

35. The system of claim 33, wherein the plurality includes up to 64 patients.

36. The system of claim 33, wherein the plurality includes more than 64 patients.

37. The system of claim 1, wherein the controller is programmably arranged to provide automated alerts of occurrence of events or circumstances requiring patient intervention.

38. The system of claim 1, wherein the controller is programmably arranged to provide a record of events of system operation.

39. The system of claim 1, wherein the controller is programmably arranged to provide reports according to specific report criteria or schedules.

40. The system of claim 1, wherein the controller is programmably arranged to transmit information to a healthcare facility computer system to administer at least one of the functions of the group consisting of: billing functions, inventory control and process automation.

41. The system of claim 1, wherein the reader includes a smart card.

42. The system of claim 41, wherein the smart card includes an RFID antenna connection.

43. The system of claim 41, wherein the smart card includes a multiplicity of RFID antenna connections.

44. The system of claim 1, wherein the controller is wirelessly coupleable in communication with the reader.

45. A system for administration of medical products, comprising an RFID tag containing information relevant to treatment of a patient, a reader arranged to receive signals from the RFID tag, and a controller operatively coupleable in communication with the reader to process information received by the reader and to responsively generate an output relating to treatment of the patient.

46. The system of claim 45, wherein the reader includes a plurality of radio frequency antenna connections for communications with a plurality of patient installations.

47. The system of claim 45 wherein said RFID tag includes at least one of (i) a first RFID tag containing patient information, and (ii) a second RFID tag containing medical product information.

48. A medical fluid bag stand, comprising an RFID antenna for reading bags labeled with RFID tags that are mounted on said stand.

49. The medical fluid bag stand of claim 48, wherein the RFID antenna is integrally formed in said stand.

50. The medical fluid bag stand of claim 49, wherein the stand includes a hook portion having the RFID antenna integrally formed therein.

51. A method of administering medical products to patients, comprising providing an RFID tagged patient and an RFID tagged medical product for said patient, wherein RFID tags for said patient and said medical product contain information relevant to administration of said medical product to said patient, and processing information from said RFID tags to produce an output relating to treatment of said patient.

52. The method of claim 51, further comprising the step of controlling the administration of said medical product to said patient in accordance with said output.

53. The method of claim 52, wherein said controlling the administration comprises dispensing said medical product to said patient or withholding said medical product from said patient.

54. The method of claim 52, wherein said controlling the administration comprises controlling rate of dispensing of said medical product to said patient.

55. A method of administering medical products to patients, comprising providing an RFID tag containing information relevant to treatment of a patient, reading said information with a reader, and processing the read information to produce an output relating to treatment of said patient.

56. The method of claim 55, wherein the reader includes a smart card including a multiplicity of RF antenna connections, and a multiplicity of RFID tags associated with different patients, with each RF antenna connection arranged for communication with a different one of the multiplicity of RFID tags associated with the different patients.

57. A system for medical patient care, comprising one or more monitoring devices arranged to monitor a patient, said one or more monitoring devices providing patient monitoring data that is readable by an RF reader, an RF reader arranged to read patient monitoring data from said one or more monitoring devices, and a controller operatively coupleable in communication with the RF reader to receive patient monitoring data from the RF reader and to responsively generate an output relating to treatment of the patient.

58. The system of claim 57, wherein said one or more monitoring devices includes an RFID tag.

59. The system of claim 57, wherein said patient monitoring data includes patient vital signs data.

60. The system of claim 59, wherein said patient vital signs data includes at least one of heart rate, temperature and blood pressure.
